(19) United States
(12) Patent Application Publication
(10) Pub. No.: US 2026/0231207 A1
(43) Pub. Date: Aug. 6, 2026

(54) SCHEDULING-BASED NON-PRIMARY CHANNEL ACCESS OPERATION USING TARGET WAKE TIME MECHANISMS

(71) Applicant: Senscomm Semiconductor Co., Ltd., Suzhou (CN)

(72) Inventors: Sung Jin PARK, Seoul (KR); DAEHONG KIM, Laguna Hills, CA (US)

(21) Appl. No.: 19/460,200

(22) Filed: Jan. 26, 2026

Related U.S. Application Data
(60) Provisional application No. 63/749,381, filed on Jan. 24, 2025.

(51) Int. Cl. H04W 74/04; H04W 52/02; H04W 72/0453; H04W 76/14

(52) U.S. Cl. CPC H04W 74/04; H04W 52/0274; H04W 72/0453; H04W 76/14

(57) ABSTRACT

A wireless communication device for facilitating wireless communication may transmit, using a basic service set (BSS) primary channel, a first frame including a target wake time (TWT) schedule for a non-primary channel access (NPCA) operation to a non-access point (non-AP) station (STA). The wireless communication device may switch an operating channel from the BSS primary channel to a NPCA primary channel at the beginning of a TWT service period indicated by the TWT schedule for the NPCA operation. The wireless communication device may perform the NPCA operation using the NPCA primary channel during the TWT service period indicated by the TWT schedule for the NPCA operation.

### CROSS REFERENCE TO RELATED APPLICATION

This application claims benefit of U.S. Provisional Application No. 63/749,381 filed on January 24, 2025, in the United States Patent and Trademark Office the entire contents of which are hereby incorporated by reference.

### TECHNICAL FIELD

This disclosure relates to wireless communication systems, and more specifically, to a scheduling-based non-primary channel access (NPCA) operation using Restricted Target Wake Time (R-TWT) mechanisms.

### BACKGROUND

The IEEE 802.11be Extremely High Throughput (EHT) task group develops the next generation Wi-Fi standard to achieve higher data rate, lower latency, and more reliable connection to enhance user experience. One of the key features of the next generation Wi-Fi standard is the Multi-Link Operation (MLO). As most current APs and stations incorporate dual-band or tri-band capabilities, the newly developed MLO feature enables packet-level link aggregation in the MAC layer across different PHY links. By performing load balancing according to traffic requirements, MLO can achieve significantly higher throughput and lower latency for enhanced reliability in a heavily loaded network. With the MLO capability, a Multi-Link Device (MLD) comprises multiple “affiliated” devices to the upper logical link control (LLC) layer, allowing concurrent data transmission and reception in multiple channels across a single or multiple frequency bands in 2.4GHz, 5GHz and 6GHz.

There exists Wi-Fi technologies that allow a device to connect to a single link and is capable of switching among 2.4GHz, 5GHz and 6GHz bands. However, such Wi-Fi devices typically have a switching overhead or delay of up to 100ms. Therefore, MLO may be highly desirable for real-time applications like video calls, wireless VR headsets, cloud gaming and other latency-sensitive applications. The IEEE 802.11be draft spec defines different channel access methods according to two transmission modes: asynchronous and synchronous modes. Under asynchronous transmission mode, a MLD transmits frames asynchronously across multiple links without aligning the starting time. In contrast, in synchronous transmission mode the starting times are aligned across the links. In either mode, the links may have their own primary channel and parameters, including Packet Protocol Data Unit (PPDU), Modulation and Coding Scheme (MCS), Enhanced Distributed Channel Access (EDCA), etc.

The increasing demand for low-latency and high-throughput communication in wireless networks has led to congestion on primary Basic Service Set (BSS) channels. This congestion negatively impacts the quality of service (QoS) for applications requiring stringent latency and throughput guarantees. Existing solutions often fail to address the efficient allocation of non-primary channels while minimizing interference from overlapping BSS (OBSS). Therefore, a need exists for a method to optimize NPCA operations through intelligent scheduling and prioritization mechanisms.

The description set forth in the background section should not be assumed to be prior art merely because it is set forth in the background section. The background section may describe aspects or embodiments of the present disclosure.

### SUMMARY

Some aspects of this disclosure are directed to improvements to non-primary channel access (NPCA) operation.

In some embodiments, a wireless communication device for facilitating wireless communication may comprise processing circuitry configured to cause: transmitting, using a basic service set (BSS) primary channel, a target wake time (TWT) schedule for a non-primary channel access (NPCA) operation to a non-access point (non-AP) station (STA); switching an operating channel from the BSS primary channel to a NPCA primary channel at the beginning of a TWT service period indicated by the TWT schedule for the NPCA operation; and performing the NPCA operation using the NPCA primary channel during the TWT service period indicated by the TWT schedule for the NPCA operation.

In some embodiments, the TWT schedule for the NPCA operation includes information indicating a channel number of a channel used for the NPCA primary channel.

In some embodiments, the TWT schedule for the NPCA operation includes one or more TWT parameters indicating one or more TWT service periods during which the NPCA operation is performed.

In some embodiments, the TWT schedule for the NPCA operation further includes information about one or more non-AP stations selected for the TWT schedule for the NPCA operation.

In some embodiments, the processing circuitry is further configured to cause: receiving status information from the non-AP STA; and scheduling TWT based on the status information to generate the TWT schedule for the NPCA operation.

In some embodiments, the status information includes at least one of information about a level of interference caused by an overlapping basic service set (OBSS), information indicating whether the non-AP STA has traffic requiring low-latency, or information indicating that the non-AP STA intends to engage in a peer-to-peer (P2P) communication.

In some embodiments, the processing circuitry is further configured to cause: transmitting a status information request requesting the non-AP STA to send status information of the non-AP STA.

In some embodiments, the processing circuitry is further configured to cause: receiving, from the non-AP STA, a response indicating the non-AP STA’s intention to participate in the TWT schedule for the NPCA operation.

In some embodiments, a wireless communication device for facilitating wireless communication may comprise processing circuitry configured to cause: receiving, using a basic service set (BSS) primary channel, a target wake time (TWT) schedule for a non-primary channel access (NPCA) operation from an access point (AP) station (STA); entering a power save mode outside one or more TWT service periods indicated by the TWT schedule for the NPCA operation; waking up and switching an operating channel from the BSS primary channel to a NPCA primary channel at the beginning of a TWT service period indicated by the TWT schedule for the NPCA operation; and performing the NPCA operation using the NPCA primary channel during the TWT service period indicated by the TWT schedule for the NPCA operation.

In some embodiments, the TWT schedule for the NPCA operation includes information about which channel is used for the NPCA primary channel.

In some embodiments, the TWT schedule for the NPCA operation includes one or more TWT parameters indicating one or more TWT service periods during which the NPCA operation is performed.

In some embodiments, the TWT schedule for the NPCA operation included information about one or more non-AP stations selected for the TWT schedule for the NPCA operation.

In some embodiments, the processing circuitry is further configured to cause: transmitting status information to the AP STA.

In some embodiments, the status information includes at least one of information about a level of interference caused by an overlapping basic service set (OBSS), information indicating whether the non-AP STA has traffic requiring low-latency, or information indicating that the non-AP STA intends to engage in a peer-to-peer (P2P) communication.

In some embodiments, the processing circuitry is further configured to cause: receiving a status information request requesting a station to send status information of the station.

In some embodiments, the TWT schedule for the NPCA operation includes information about one or more non-AP stations selected for the TWT schedule for the NPCA operation.

In some embodiments, performing the NPCA operation comprises: performing wireless communication with the AP STA using the NPCA primary channel during the TWT service period indicated by the TWT schedule for the NPCA operation.

In some embodiments, performing the NPCA operation comprises: performing peer-to-peer communication with another non-AP STA using the NPCA primary channel during the TWT service period indicated by the TWT schedule for the NPCA operation.

In some embodiments, a method performed by a wireless communication device for facilitating wireless communication, may comprise: receiving, using a basic service set (BSS) primary channel, a target wake time (TWT) schedule for a non-primary channel access (NPCA) operation from an access point (AP) station (STA); entering a power save mode outside one or more TWT service periods indicated by the TWT schedule for the NPCA operation; waking up and switching an operating channel from the BSS primary channel to a NPCA primary channel at the beginning of a TWT service period indicated by the TWT schedule for the NPCA operation; and performing the NPCA operation using the NPCA primary channel during the TWT service period indicated by the TWT schedule for the NPCA operation.

In some embodiments, the method may further comprise: transmitting status information to the AP STA.

Scheduling TWT for the NPCA operation and performing the NPCA operation during the TWT service period indicated by the TWT schedule can provide minimal delays for time-sensitive traffic, particularly for applications requiring low latency and high reliability and while maintaining resource availability for other users.

Scheduling TWT for the NPCA operation and performing the NPCA operation during the TWT service period indicated by the TWT schedule can provide significant reduction of congestion on BSS primary channels, enhance channel utilization, and improve overall network performance including network throughput, network efficiency, and QoA, particularly for applications requiring low latency and high reliability.

Scheduling TWT for P2P communication according to the NPCA operation and performing the P2P communication by using the NPCA primary channel during the TWT service period indicated by the TWT schedule can provide efficient and interference-free P2P communication for STAs which intend to engage in the P2P communication.

### BRIEF DESCRIPTION OF THE DRAWINGS

FIG. 1 illustrates a schematic diagram of an example wireless communication network.

FIG. 2 illustrates an example of a timing diagram of interframe space (IFS) relationships between stations in accordance with an embodiment.

FIG. 3 shows an OFDM symbol and an OFDMA symbol in accordance with an embodiment.

FIG. 4A illustrates the EHT MU PPDU format in accordance with an embodiment.

FIG. 4B illustrates the EHT TB PPDU format in accordance with an embodiment.

FIG. 5 is a block diagram of an electronic device for facilitating wireless communication in accordance with an embodiment.

FIG. 6 shows a block diagram of a transmitter in accordance with an embodiment.

FIG. 7 shows a block diagram of a receiver in accordance with an embodiment.

FIG. 8 shows the MLO operation with two links in accordance with an embodiment.

FIG. 9 shows a Non-Primary Channel Access (NPCA) operation in accordance with an embodiment.

FIG. 10 shows a non-primary channel access (NPCA) operation in accordance with an embodiment.

FIG. 11 illustrates a scheduling-based NPCA operation utilizing TWT in accordance with an emobodiment.

FIG. 12 shows a TWT frame transmission Phase in accordance with an embodiment.

FIG. 13 shows a scheduling-based NPCA operation utilizing TWT in accordance with an embodiment.

### DETAILED DESCRIPTION

The detailed description set forth below is intended to describe various implementations and is not intended to represent the only implementation. As those skilled in the art would realize, the described implementations may be modified in various different ways, all without departing from the scope of the present disclosure. Accordingly, the drawings and description are to be regarded as illustrative in nature and not restrictive. Like reference numerals designate like elements.

The below detailed description herein has been described with reference to a wireless LAN system according to the Institute of Electrical and Electronics Engineers (IEEE) 802.11 wireless standards including the current and future amendments. However, a person having ordinary skill in the art will readily recognize that the teachings herein are applicable to other network environments, such as cellular telecommunication networks and wired telecommunication networks.

In some embodiments, apparatus or devices such as an AP STA and a non-AP may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. The apparatus may also include one or more other hardware or software elements such as a network interface and a display device.

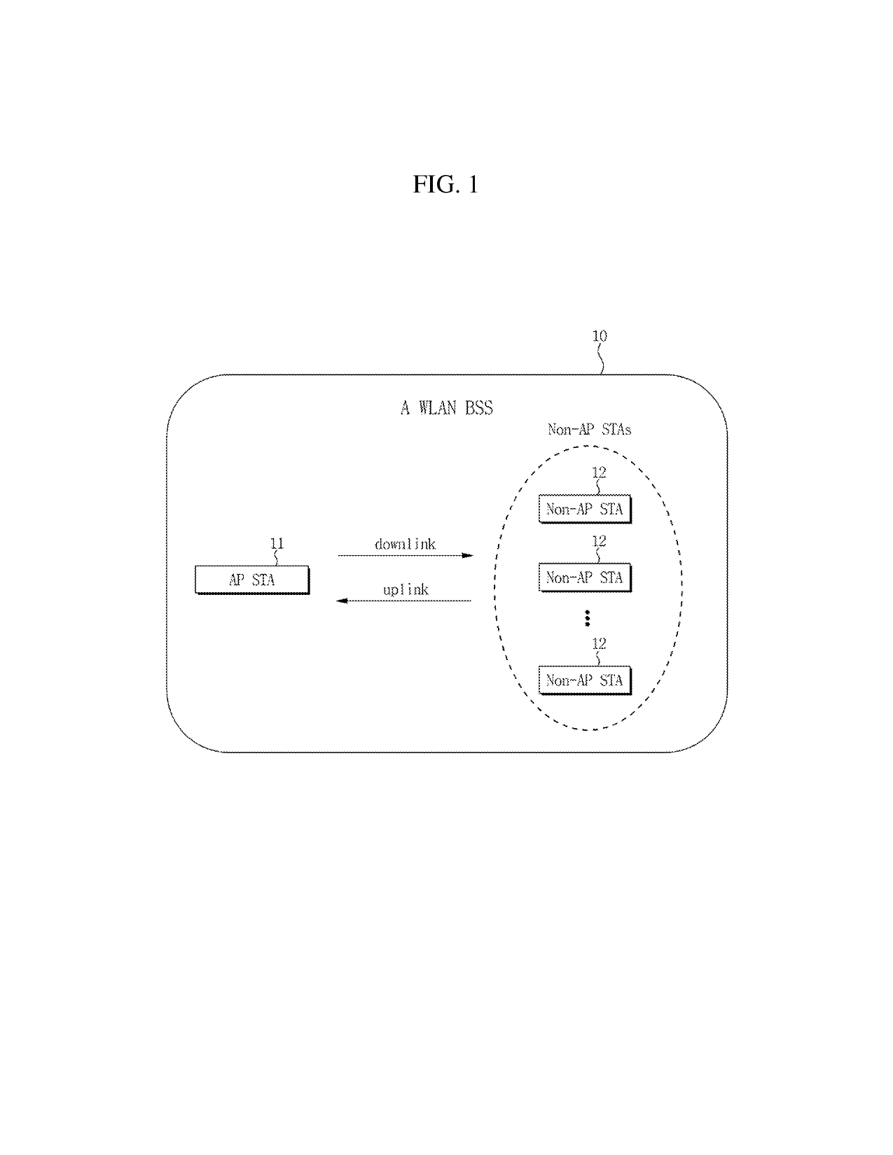

FIG. 1 illustrates a schematic diagram of an example wireless communication network.

Referring to FIG. 1, a basic service set (BSS) 10 may include a plurality of stations (STAs) including an access point (AP) station (AP STA) 11 and one or more non-AP station (non-AP STA) 12. For convenience, the non-AP STA may be referred to interchangeably as a user or an STA. The STAs may share a same radio frequency channel with one out of WLAN operation bandwidth options (e.g., 20/40/80/160/320 MHz). Hereinafter, in some embodiments, the AP STA

The plurality of STAs may participate in multi-user (MU) transmission. In the MU transmission, the AP STA 11 may simultaneously transmit the downlink (DL) frames to the multiple non-AP STAs 12 in the BSS 10 based on different resources and the multiple non-AP STAs 12 may simultaneously transmit the uplink (UL) frames to the AP STA 11 in the BSS 10 based on different resources.

For the MU transmission, multi-user multiple input, multiple output (MU-MIMO) transmission or orthogonal frequency division multiple access (OFDMA) transmission may be used. In MU-MIMO transmission, with one or more antennas, the multiple non-AP STAs 12 may either simultaneously transmit to the AP STA 11 or simultaneously receive from the AP STA 11 independent data streams over the same subcarriers. Different frequency resources may be used as the different resources in the MU-MIMO transmission. In OFDMA transmission, the multiple non-AP STAs 12 may either simultaneously transmit to the AP STA 11 or simultaneously receive from the AP STA 11 independent data streams over different groups of subcarriers. Different spatial streams may be used as the different resources in MU-MIMO transmission.

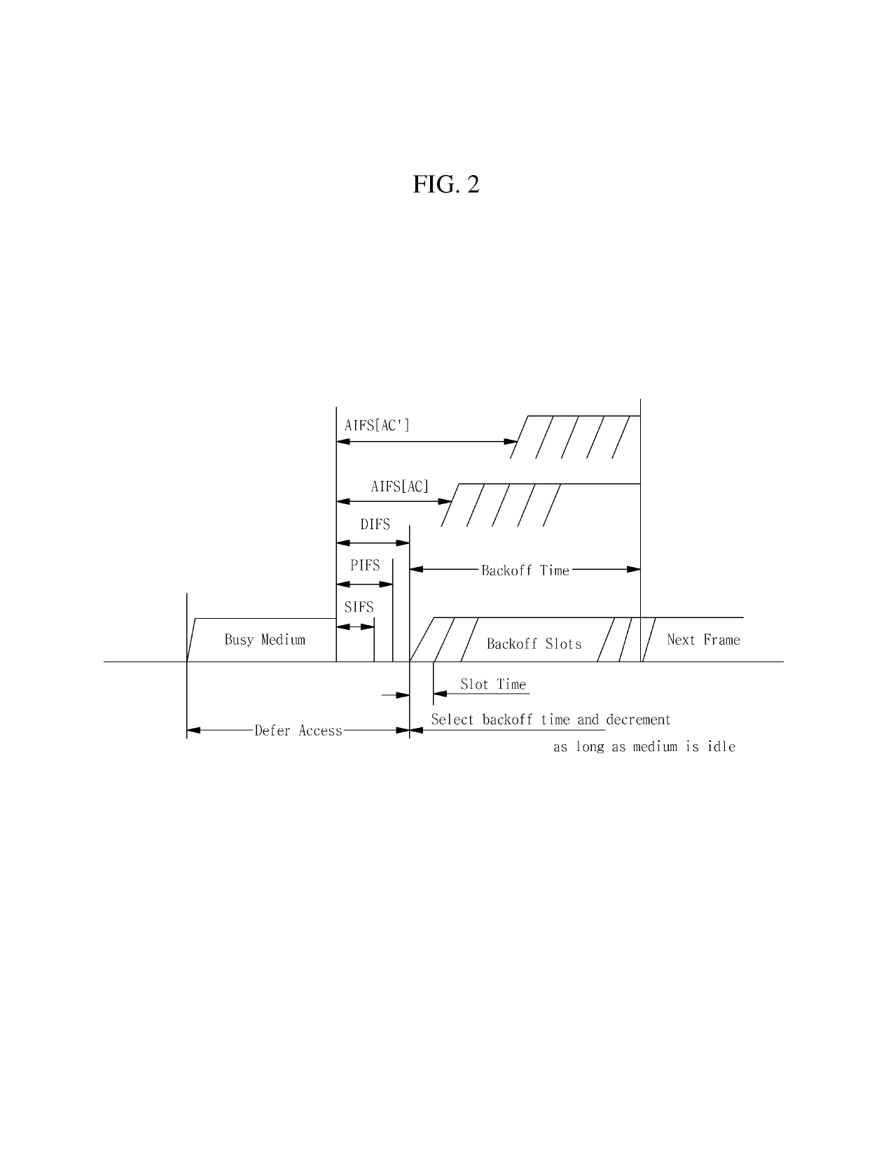

FIG. 2 illustrates an example of a timing diagram of interframe space (IFS) relationships between stations in accordance with an embodiment.

In particular, FIG. 2 shows a CSMA (carrier sense multiple access)/CA (collision avoidance) based frame transmission procedure for avoiding collision between frames in a channel.

A data frame, a control frame, or a management frame may be exchanged between STAs.

The data frame may be used for transmission of data forwarded to a higher layer. Referring to FIG. 2, access is deferred while the medium is busy until a type of IFS duration has elapsed. The STA may transmit the data frame after performing backoff if a distributed coordination function IFS (DIFS) has elapsed from a time when the medium has been idle.

The management frame may be used for exchanging management information which is not forwarded to the higher layer. Subtype frames of the management frame may include a beacon frame, an association request/response frame, a probe request/response frame, and an authentication request/response frame.

The control frame may be used for controlling access to the medium. Subtype frames of the control frame include a request to send (RTS) frame, a clear to send (CTS) frame, and an acknowledgement (ACK) frame. In the case that the control frame is not a response frame of the other frame, the STA may transmit the control frame after performing backoff if the DIFS has elapsed. If the control frame is the response frame of a previous frame, the WLAN device may transmit the control frame without performing backoff when a short IFS (SIFS) has elapsed. The type and subtype of frame may be identified by a type field and a subtype field in a frame control field.

On the other hand, a Quality of Service (QoS) STA may transmit the frame after performing backoff if an arbitration IFS (AIFS) for access category (AC), i.e., AIFS[AC] has elapsed. In this case, the data frame, the management frame, or the control frame which is not the response frame may use the AIFC[AC].

In some embodiments, a point coordination function (PCF) enabled AP STA may transmit the frame after performing backoff if a PCF IFS (PIFS) has elapsed. The PIFS duration may be less than the DIFS but greater than the SIFS.

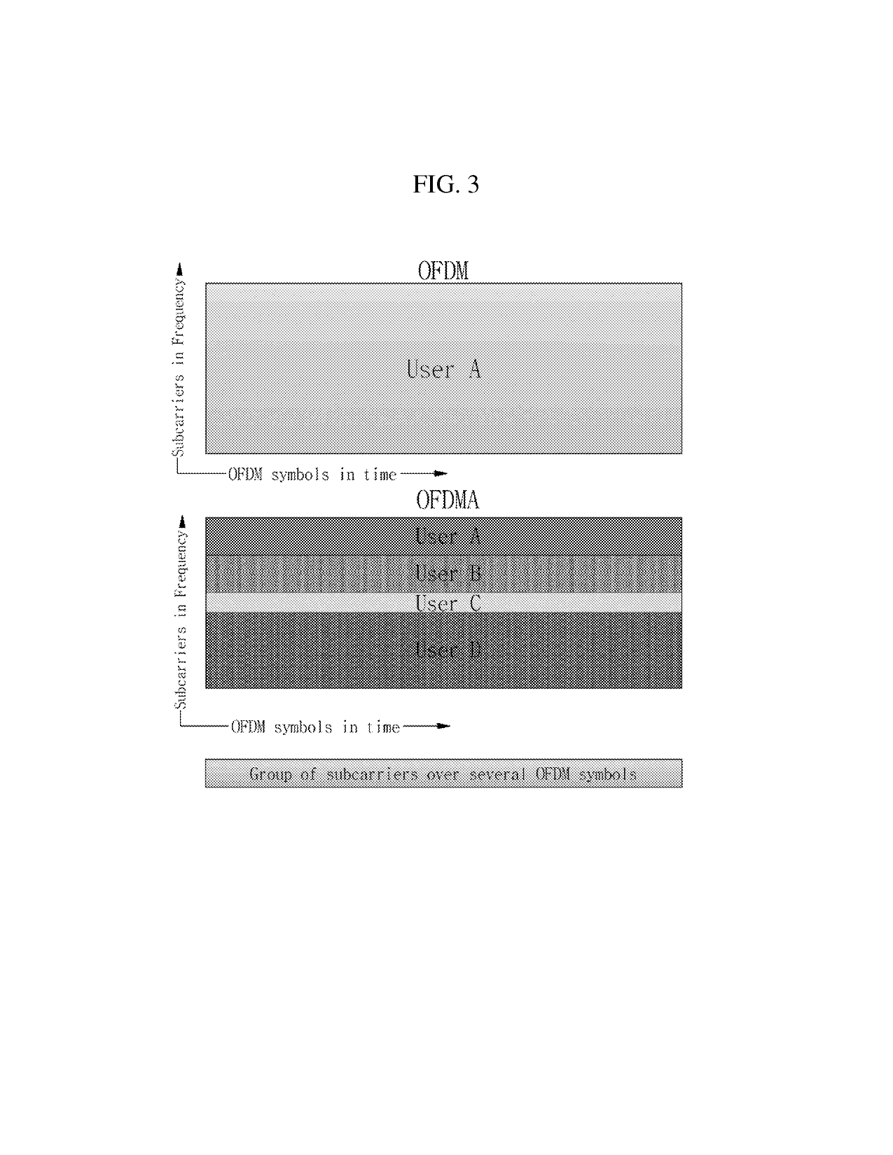

FIG. 3 shows an OFDM symbol and an OFDMA symbol in accordance with an embodiment.

For multi-user access modulation, the orthogonal frequency division multiple access (OFDMA) for uplink and downlink has been introduced in IEEE 802.11ax standard known as High Efficiency (HE) WLAN and will be used in 802.11’s future amendments such as EHT (Extreme High Throughput). One or more STAs may be allowed to use one or more resource units (RUs) throughout operation bandwidth to transmit data at the same time. As the minimum granularity, one RU may comprise a group of predefined number of subcarriers and be located at predefined location in orthogonal frequency division multiplexing (OFDM) modulation symbol. Here, non-AP STAs may be associated or non-associated with AP STA when responding simultaneously in the assigned RUs within a specific period such as a short inter frame space (SIFS). The SIFS may refer to the time duration from the end of the last symbol, or signal extension if present, of the previous frame to the beginning of the first symbol of the preamble of the subsequent frame.

The OFDMA is an OFDM-based multiple access scheme where different subsets of subcarriers may be allocated to different users, allowing simultaneous data transmission to or from one or more users with high accurate synchronization for frequency orthogonality. In OFDMA, users may be allocated different subsets of subcarriers which can change from one physical layer (PHY) protocol data unit (PPDU) to the next. In OFDMA, an OFDM symbol is constructed of subcarriers, the number of which is a function of the PPDU bandwidth. The difference between OFDM and OFDMA is illustrated in FIG. 3.

In a case of UL MU transmission, given different STAs with their own capabilities and features, the AP STA may want to have more control mechanism of the medium by using more scheduled access, which may allow more frequent use of OFDMA/MU-MIMO transmissions. PPDUs in UL MU transmission (MU-MIMO or OFDMA) may be sent as a response to the trigger frame sent by the AP. The trigger frame may have STA’s information and assign RUs and multiple RUs (MRUs) to STAs. The STA’s information in the trigger frame may comprise STA Identification (ID), MCS (modulation and coding scheme), and frame length. The trigger frame may allow an STA to transmit trigger-based (TB) PPDU (e.g., HE TB PPDU or EHT TB PPDU) which is segmented into an RU and all RUs as a response of Trigger frame are allocated to the solicited non-AP STAs accordingly. Hereafter, a single RU and a multiple RU may be referred to as the RU. The multiple RU may include, or consist of, predefined two, three, or more RUs.

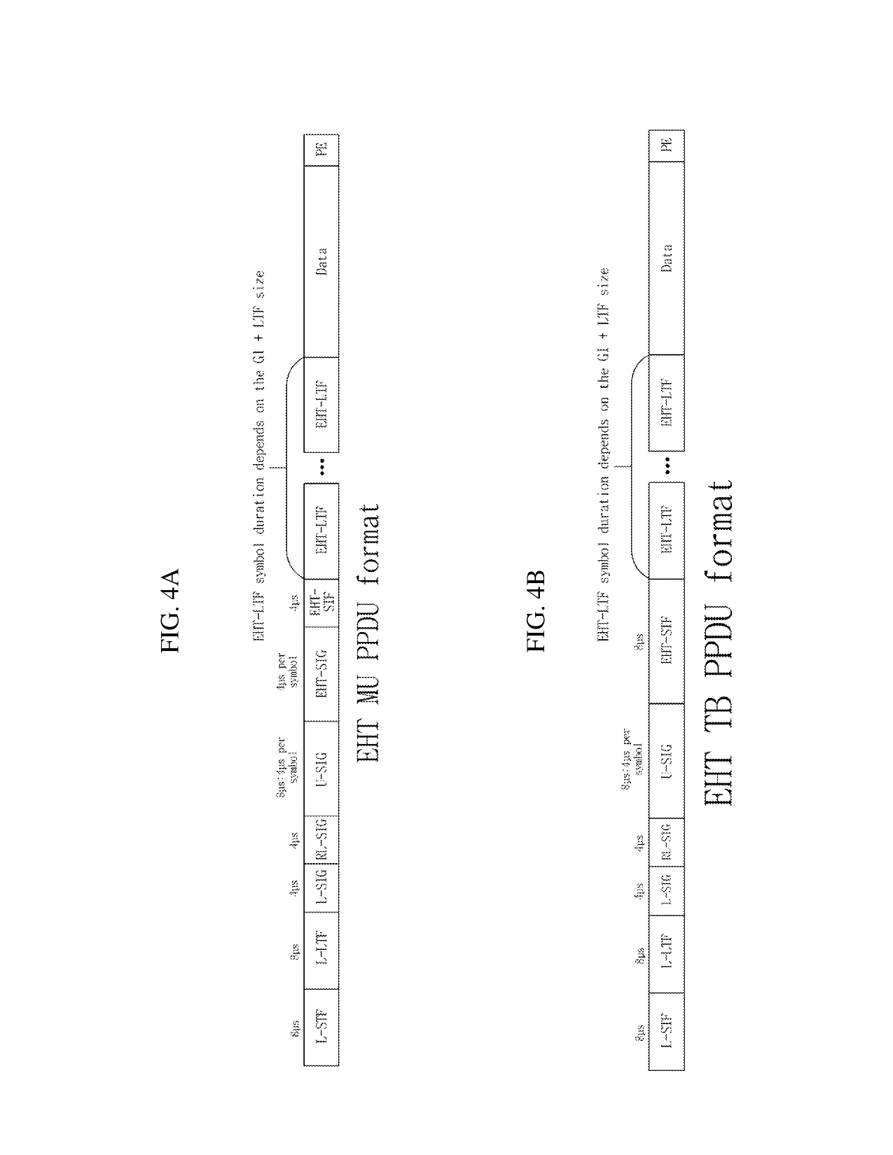

In EHT amendment, two EHT PPDU formats are defined: the EHT MU PPDU and the EHT TB PPDU. Hereinafter, the EHT MU PPDU and the EHT TB PPDU will be described with reference to FIG. 4A and FIG. 4B.

FIG. 4A illustrates the EHT MU PPDU format in accordance with an embodiment.

The EHT MU PPDU may be used for transmission to one or more users. The EHT MU PPDU is not a response to a triggering frame.

Referring to FIG. 4A, the EHT MU PPDU may include, or consist of, an EHT preamble (hereinafter referred to as a PHY preamble or a preamble), a data field, and a packet extension (PE) field. The EHT preamble may include, or consist of, pre-EHT modulated fields and EHT modulated fields. The pre-EHT modulated fields may include, or consist of, a Non-HT short training field (L-STF), a Non-HT long training field (L-LTF), a Non-HT signal (L-SIG) field, a repeated Non-HT signal (RL-SIG) field, a universal signal (U-SIG) field, and an EHT signal (EHT-SIG) field. The EHT modulated fields may include, or consist of, an EHT short training field (EHT-STF) and an EHT long training field (EHT-LTF). In some embodiments, the L-STF may be immediately followed by the L-LTF immediately followed by the L-SIG field immediately followed by the RL-SIG field immediately followed by the U-SIG field immediately followed by the EHT-SIG field immediately followed by the EHT-STF immediately followed by the EHT-LTF immediately followed by the data field immediately followed by the PE field.

The L-STF field may be utilized for packet detection, automatic gain control (AGC), and coarse frequency-offset correction.

The L-LTF field may be utilized for channel estimation, fine frequency-offset correction, and symbol timing.

The L-SIG field may be used to communicate rate and length information.

The RL-SIG field may be a repeat of the L-SIG field and may be used to differentiate an EHT PPDU from a non-HT PPDU, HT PPDU, and VHT PPDU.

The U-SIG field may carry information necessary to interpret EHT PPDUs.

The EHT-SIG field may provide additional signaling to the U-SIG field for STAs to interpret an EHT MU PPDU. Hereinafter, the U-SIG field, the EHT-SIG field, or both may be referred to as the SIG field.

The EHT-SIG field may include one or more EHT-SIG content channel. Each of the one or more EHT-SIG content channel may include a common field and a user specific field. The common field may contain information regarding the resource unit allocation such as the RU assignment to be used in the EHT modulated fields of the PPDU, the RUs allocated for MU-MIMO and the number of users in MU-MIMO allocations. The user specific field may include one or more user fields.

The user field for a non-MU-MIMO allocation may include a STA-ID subfield, a MCS subfield, a NSS subfield, a beamformed subfield, and a coding subfield. The user field for a MU-MIMO allocation may include a STA-ID subfield, a MCS subfield, a coding subfield, and a spatial configuration subfield.

The EHT-STF field may be used to improve automatic gain control estimation in a MIMO transmission.

The EHT-LTF field may enable the receiver to estimate the MIMO channel between the set of constellation mapper outputs and the receive chains.

The data field may carry one or more physical layer convergence procedure (PLCP) service data units (PSDUs).

The PE field may provide additional receive processing time at the end of the EHT MU PPDU.

FIG. 4B illustrates the EHT TB PPDU format in accordance with an embodiment.

The EHT TB PPUD may be used for a transmission of a response to a triggering frame.

Referring to FIG. 4B, the EHT TB PPDU may include, or consist of, an EHT preamble (hereinafter referred to as a PHY preamble or a preamble), a data field, and a packet extension (PE) field. The EHT preamble may include, or consist of, pre-EHT modulated fields and EHT modulated fields. The pre-EHT modulated fields may include, or consist of, a Non-HT short training field (L-STF), a Non-HT long training field (L-LTF), a Non-HT signal (L-SIG) field, a repeated Non-HT signal (RL-SIG) field, and a universal signal (U-SIG) field. The EHT modulated fields may include, or consist of, an EHT short training field (EHT-STF) and an EHT long training field (EHT-LTF). In some embodiments, the L-STF may be immediately followed by the L-LTF immediately followed by the L-SIG field immediately followed by the RL-SIG field immediately followed by the U-SIG field immediately followed by the EHT-STF immediately followed by the EHT-LTF immediately followed by the data field immediately followed by the PE field. In the EHT TB PPUD, the EHT-SIG field is not present because the trigger frame conveys necessary information and the duration of the EHT_STF field in the EHT TB PPUD is twice the duration of the EHT-STF field in the EHT MU PPDU.

Description for each field in the EHT TB PPDU will be omitted because description for each field in the EHT MU PPDU is applicable to the EHT TB PPDU.

For EHT MU PPDU and EHT TB PPUD, when the EHT modulated fields occupy more than one 20 MHz channels, the pre-EHT modulated fields may be duplicated over multiple 20 MHz channels.

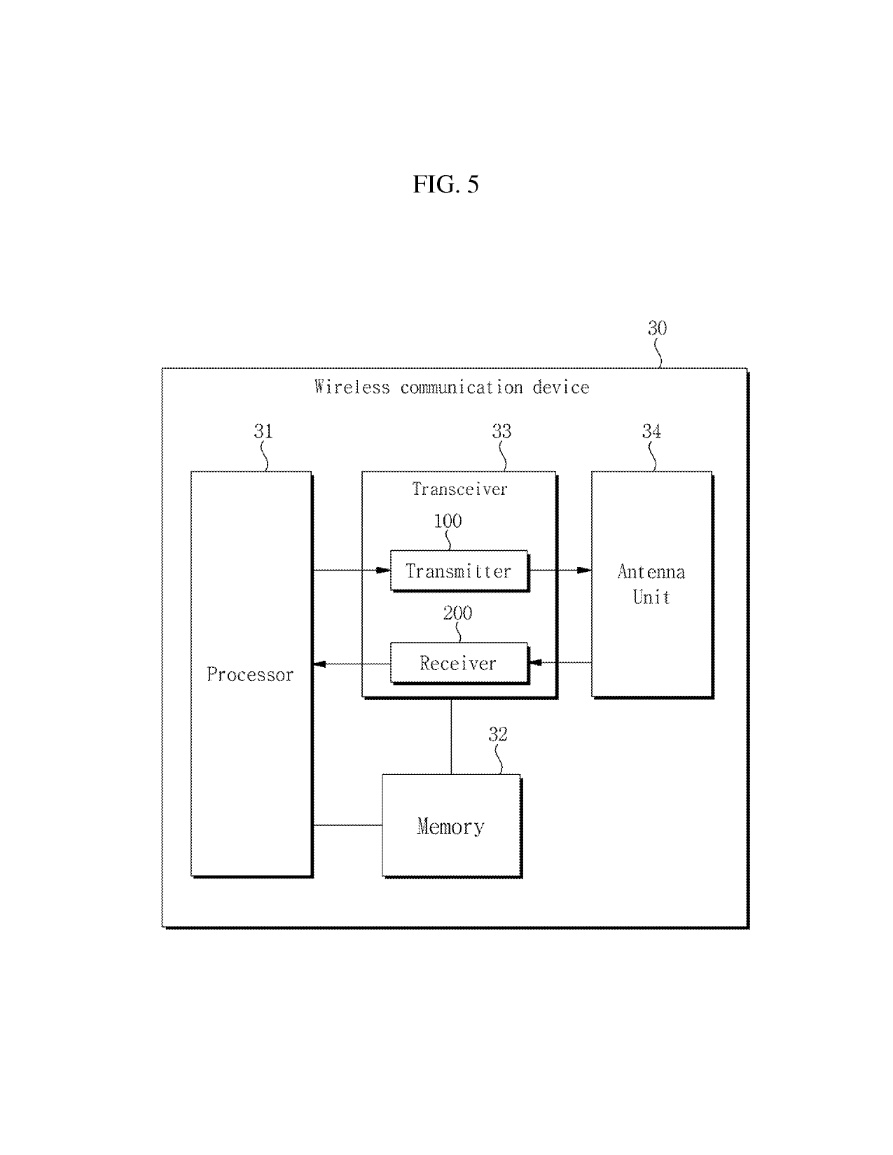

Hereinafter, electronic devices for facilitating wireless communication in accordance with various embodiments will be described with reference to FIG. 5.

FIG. 5 is a block diagram of an electronic device for facilitating wireless communication in accordance with an embodiment.

Referring to FIG. 5, an electronic device 30 for facilitating wireless communication in accordance with an embodiment may include a processor 31, a memory 32, a transceiver 33, and an antenna unit 34. The transceiver 33 may include a transmitter 100 and a receiver 200.

The processor 31 may perform medium access control (MAC) functions, PHY functions, RF functions, or a combination of some or all of the foregoing. In some embodiments, the processor 31 may comprise some or all of a transmitter 100 and a receiver 200. The processor 31 may be directly or indirectly coupled to the memory 32. In some embodiments, the processor 31 may include one or more processors.

The memory 32 may be non-transitory computer-readable recording medium storing instructions that, when executed by the processor 31, cause the electronic device 30 to perform operations, methods or procedures set forth in the present disclosure. In some embodiments, the memory 32 may store instructions that are needed by one or more of the processor 31, the transceiver 33, and other components of the electronic device 30. The memory may further store an operating system and applications. The memory 32 may comprise, be implemented as, or be included in a read-and-write memory, a read-only memory, a volatile memory, a non-volatile memory, or a combination of some or all of the foregoing.

The antenna unit 34 includes one or more physical antennas. When multiple-input multiple-output (MIMO) or multi-user MIMO (MU-MIMO) is used, the antenna unit 34 may include more than one physical antennas.

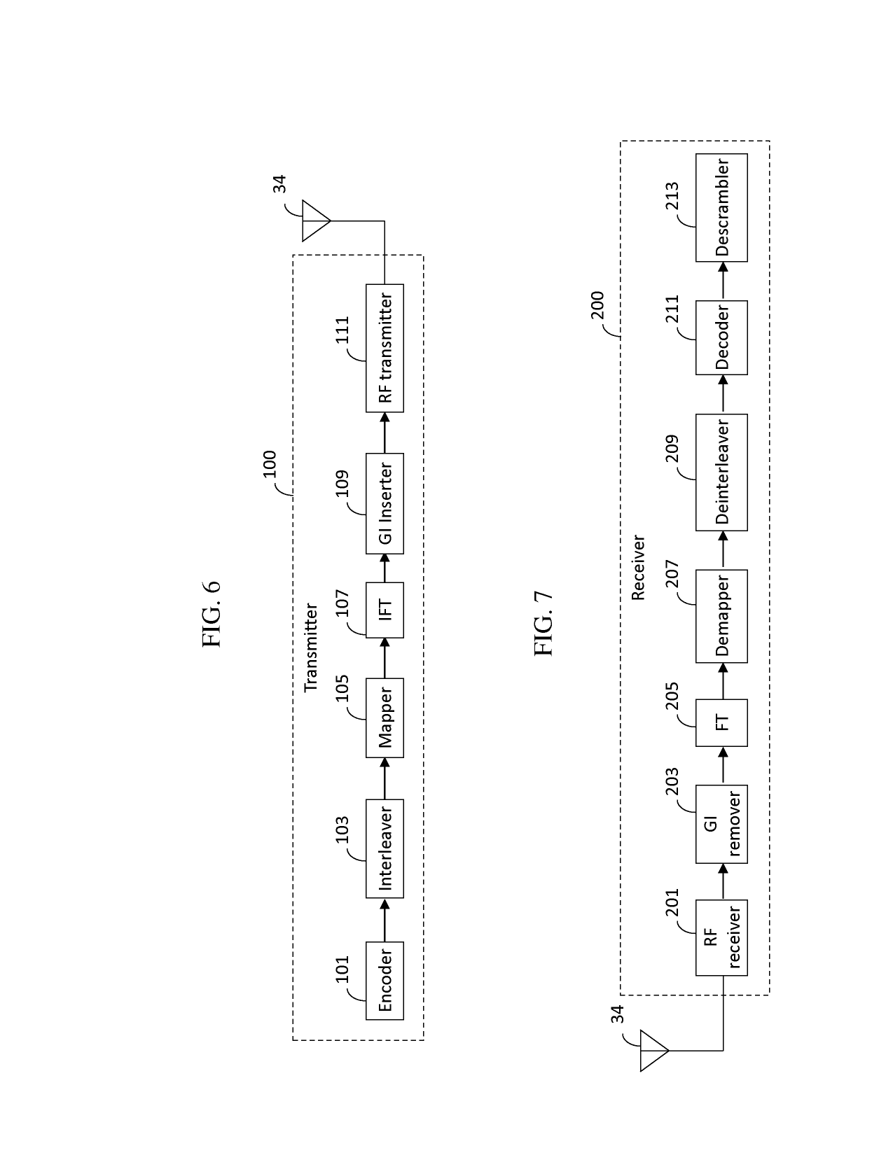

FIG. 6 shows a block diagram of a transmitter in accordance with an embodiment.

Referring to FIG. 7, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder.

The interleaver 103 may interleave bits of encoded data from the encoder 101 to change the order of bits, and output interleaved data. In some embodiments, interleaving may be applied when BCC encoding is employed.

The mapper 105 may map interleaved data into constellation points to generate a block of constellation points. If the LDPC encoding is used in the encoder 101, the mapper 105 may further perform LDPC tone mapping instead of the constellation mapping.

The IFT 107 may convert the block of constellation points into a time domain block corresponding to a symbol by using an inverse discrete Fourier transform (IDFT) or an inverse fast Fourier transform (IFFT).

The GI inserter 109 may prepend a GI to the symbol.

The RF transmitter 111 may convert the symbols into an RF signal and transmits the RF signal via the antenna unit 34.

FIG. 7 shows a block diagram of a receiver in accordance with an embodiment.

Referring to FIG. 7, the receiver 200 in accordance with an embodiment may include a RF receiver 201, a GI remover 203, a Fourier transformer (FT) 205, a demapper 207, a deinterleaver 209, and a decoder 211.

The RF receiver 201 may receive an RF signal via the antenna unit 34 and converts the RF signal into one or more symbols.

The GI remover 203 may remove the GI from the symbol.

The FT 205 may convert the symbol corresponding a time domain block into a block of constellation points by using a discrete Fourier transform (DFT) or a fast Fourier transform (FFT) depending on implementation.

The demapper 207 may demap the block of constellation points to demapped data bits. If the LDPC encoding is used, the demapper 207 may further perform LDPC tone demapping before the constellation demapping.

The deinterleaver 209 may deinterleave demapped data bits to generate deinterleaved data bits. In some embodiments, deinterleaving may be applied when BCC encoding is used.

The decoder 211 may decode the deinterleaved data bits to generate decoded bits. For example, the decoder 211 may be an FEC decoder. The FEC decoder may include a BCC decoder or an LDPC decoder. In order to support the HARQ procedure, the decoder 211 may combine a retransmitted data with an initial data.

The descrambler 213 may descramble the descrambled data bits based on a scrambler seed.

Hereinafter, a multi-link operation (MLO) in accordance with an embodiment will be described.

The IEEE 802.11be Extremely High Throughput (EHT) task group is currently developing the next generation Wi-Fi standard to achieve higher data rate, lower latency, and more reliable connection to enhance user experience. One of the key features of the IEEE 802.11be standard is a multi-link operation (MLO). As most of the AP STAs and the non-AP STAs incorporate dual-band or tri-band capabilities, the newly developed MLO feature may enable packet-level link aggregation in the MAC layer across different PHY links. By performing load balancing according to traffic requirements, the MLO may achieve significantly higher throughput and lower latency for enhanced reliability in a heavily loaded network. With the MLO capability, a multi-link device (MLD) includes multiple affiliated devices to the upper logical link control (LLC) layer, allowing concurrent data transmission and reception in multiple channels across a single or multiple frequency bands in 2.4GHz, 5GHz and 6GHz.

There exists Wi-Fi technologies that allow a Wi-Fi device to connect to a single link and enable the Wi-Fi device to switch among 2.4GHz, 5GHz and 6GHz bands. However, such Wi-Fi devices typically have a switching overhead or delay of up to 100ms. Therefore, the MLO is highly desirable for real-time applications like video calls, wireless VR headsets, cloud gaming and other latency-sensitive applications. The IEEE 802.11be draft specification defines different channel access methods according to two transmission modes: asynchronous and synchronous modes. Under asynchronous transmission mode, the MLD transmits frames asynchronously across multiple links without aligning the starting time. In contrast, in synchronous transmission mode, the starting times are aligned across the links. In either mode, the links may have their own primary channel and parameters, including Packet Protocol Data Unit (PPDU), Modulation and Coding Scheme (MCS), Enhanced Distributed Channel Access (EDCA), etc.

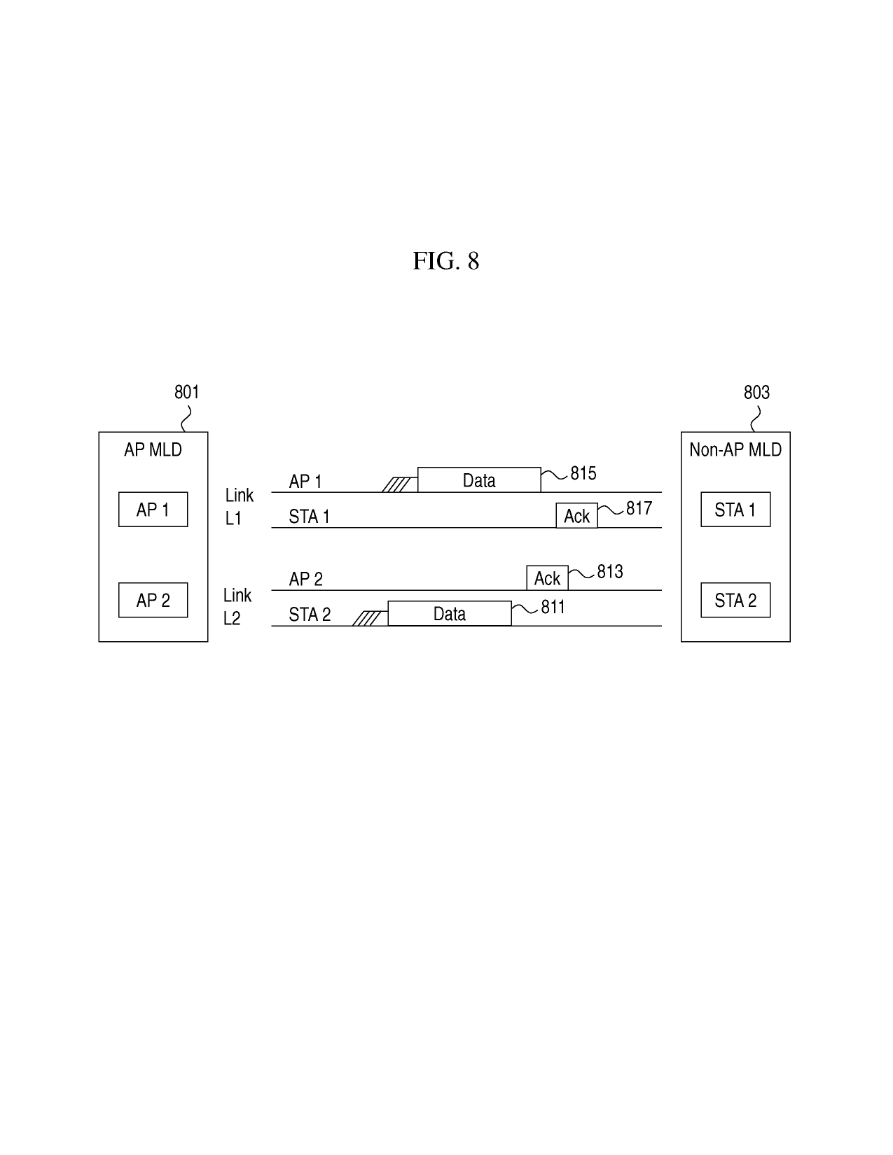

Hereinafter, a Multi-link Operation (MLO) will be described with reference to FIG. 8.

FIG. 8 shows the MLO operation with two links in accordance with an embodiment.

Referring to FIG. 8, the AP MLD 801 may comprise a plurality of APs including AP 1 and AP 2, and the non-AP MLD may comprise a plurality of STAs including STA 1 and STA 2. The AP 1 may have a buffer containing data units including data units to be transmitted to the STA 1, the AP 2 may have a buffer containing data units including data units to be transmitted to the STA 2, the STA 1 may have a buffer containing data units including data units to be transmitted to the AP 1, and the STA 2 may have a buffer containing data units including data units to be transmitted to the AP 2.

The STA 2 of the non-AP MLD 803 may check whether a backoff counter for the link L2 reaches 0. When the backoff counter for the link L2 reaches 0, the STA 2 of the non-AP MLD 803 may transmit the data unit 811 to the AP 2 via the link L2. The AP 2 of the AP MLD 801 may transmit an Ack frame 813 for the data unit 811 to the STA 2 via the link L2 a SIFS after the AP 2 successfully receives the data unit 811.

Even during the AP 2’s reception of the data unit 811, the AP 1 of the AP MLD 801 may check whether a backoff counter for the link L1 reaches 0. When the backoff counter for the link L1 reaches 0, the AP 1 of the AP MLD 801 may transmit the data unit 815 to the STA 1 via the link L1 even during the AP 2’s reception of the data unit 811. The STA 1 of the non-AP MLD 803 may transmit an Ack frame 817 for the data unit 815 to the AP 1 via link L1 a SIFS after the STA 1 successfully receives the data unit 815.

In the embodiment of FIG. 8, the AP MLD 801 may complete receiving the data unit 811 via the link L2 first, and then the non-AP MLD 803 may complete receiving the data unit 815 via the link L1.

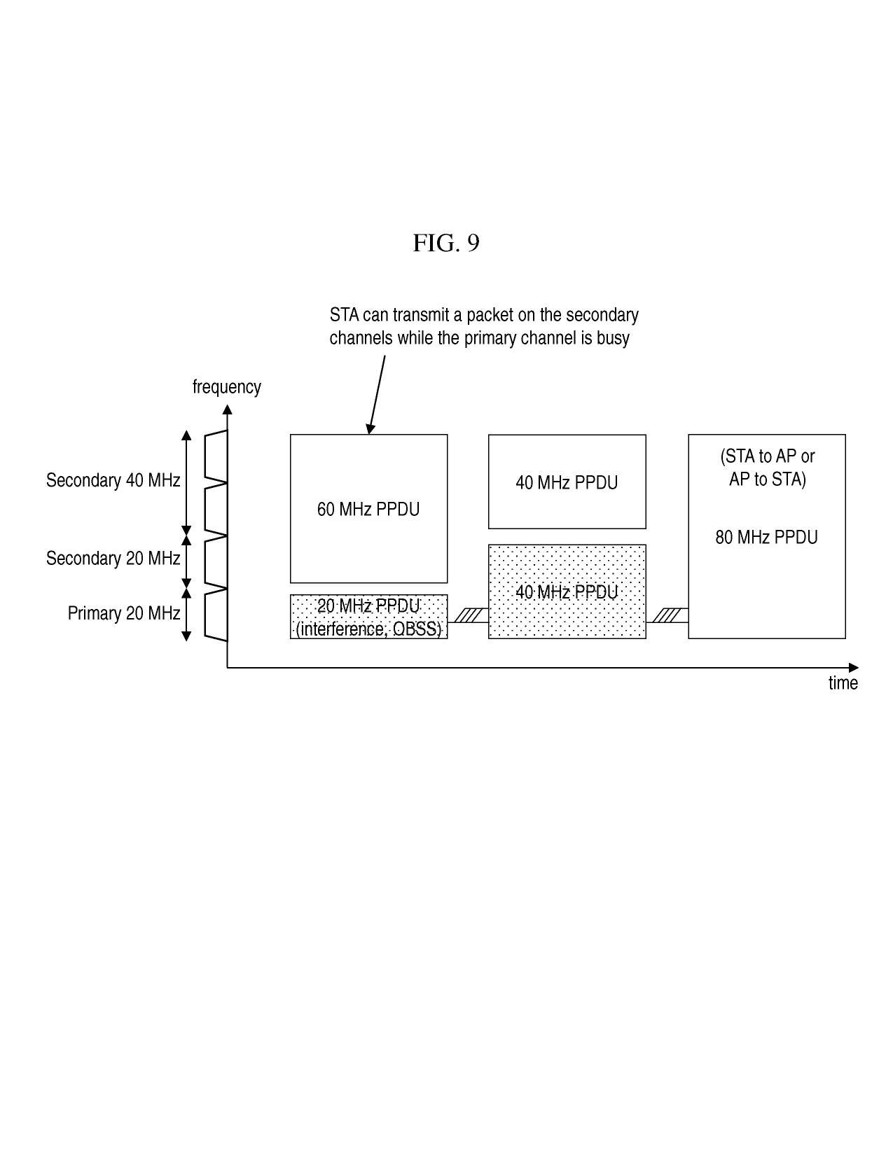

Hereinafter, the Non-primary Channel Access will be described with reference to FIG. 9.

FIG. 9 shows a Non-Primary Channel Access (NPCA) operation in accordance with an embodiment.

Referring to FIG. 9, the operating channel width available to the AP (Access Point) is 80 MHz. If traffic signals from an OBSS (Overlapping Basic Service Set) interfere with some channels, including the BSS primary channel, the entire BSS operating channels become unusable even if the remaining channels are idle. This leads to inefficiency in terms of channel utilization.

To address this problem, the Non-Primary Channel Access (NPCA) technology is being considered in next-generation Wi-Fi standards.

According to NPCA, when interference occurs on the primary channel (BSS Primary Channel) due to external OBSS activities, the AP and non-AP STA may switch to a pre-negotiated auxiliary channel (NPCA Primary Channel) to transmit data.

Hereinafter, the r-TWT (restricted Target Wake Time) Procedure will be described.

The r-TWT procedure is a mechanism introduced in Wi-Fi 6 (802.11ax) and later standards to enhance energy efficiency and network performance. It allows client devices (STAs) to coordinate their wake and sleep times with an access point (AP), minimizing power consumption and reducing network congestion.

During a TWT setting negotiation phase, the AP and STA may negotiate the TWT session parameters. These parameters may include a TWT period specifying the frequency of the wake time, an active duration specifying how long the STA stays awake during the TWT period, and a scheduled TWT slot allocating a specific time window for data transmission and reception.

During a TWT Schedule generation phase, the AP may create TWT schedules tailored for individual STAs. This ensures efficient allocation of network resources and avoids interference between multiple STAs.

During a STA sleep and wake management phase, the STA may follow the negotiated schedule, staying in low-power mode (sleep state) outside the scheduled TWT periods. The STA may wake up only during its designated TWT periods for data communication.

During a TWT frame transmission phase, data exchange may occur between the STA and the AP during the scheduled TWT period. Outside the TWT period, the STA may remain inactive, conserving energy and reducing channel contention.

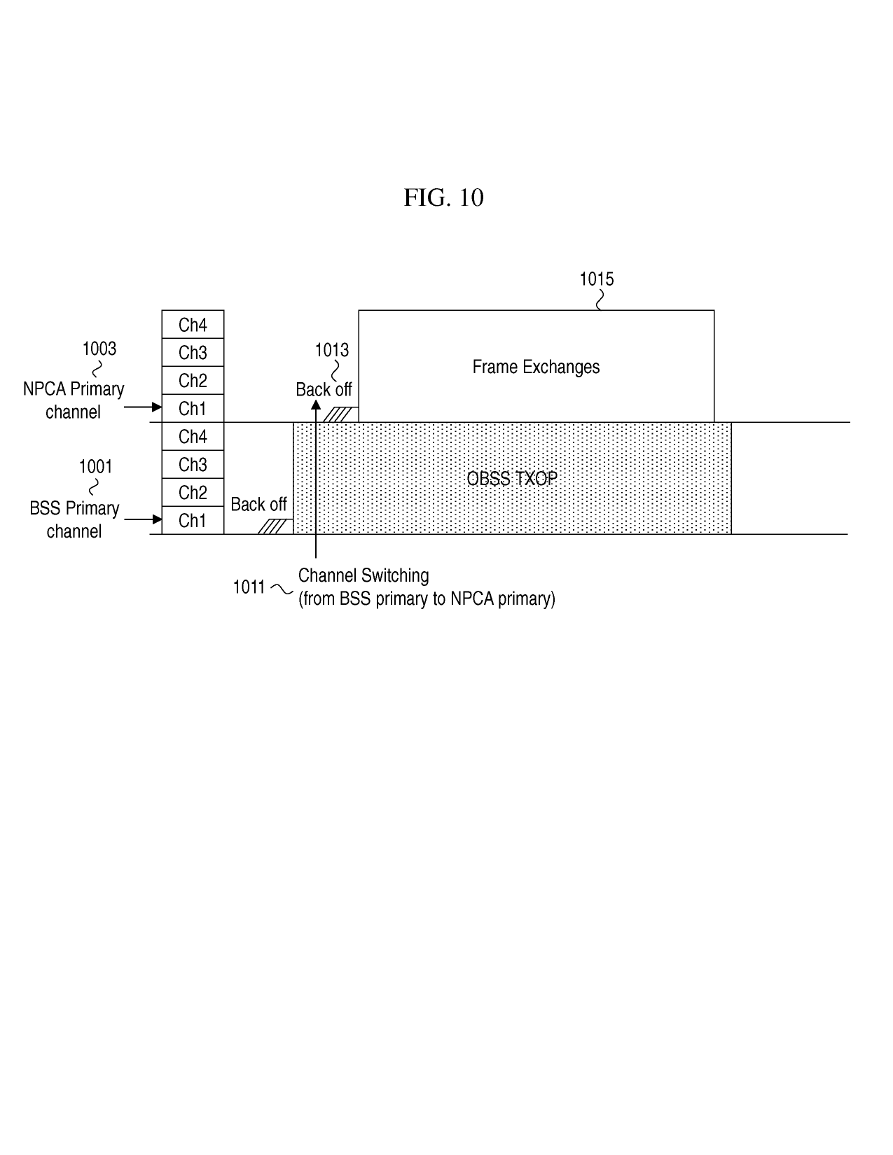

Hereinafter, the NPCA Operation Procedure will be described with reference to FIG. 10.

FIG. 10 shows a non-primary channel access (NPCA) operation in accordance with an embodiment.

The AP and STA may announce their NPCA support capability through Beacon frames or Probe Request/Response frames. The AP may inform the STAs of which channel is the NPCA primary channel 1003.

When the AP and STA receive HE PPDU signals, EHT PPDU signals, or UHR (Ultra-High Reliability) PPDU signals from another BSS (OBSS) and determine them as interference, they may switch their primary channel from the BSS primary channel 1001 to the NPCA primary channel 1003, as shown in FIG. 10.

Once the switch 1011 is made, a new backoff counter 1013 is set, and Enhanced Distributed Channel Access (EDCA) rules are reinitialized and applied to the NPCA primary channel 1003. Frame exchanges 1015 may be then conducted under these updated rules.

Hereinafter, the NPCA operation using R-TWT in accordance with an embodiment will be described.

The NPCA operation using R-TWT in accordance with an embodiment may include the following aspects: interference measurement, low-latency traffic identification, and peer-to-peer (p2p) communication, and congestion mitigation.

For interference measurement, the Access Points (APs) may periodically instruct Stations (STAs) to measure interference levels caused by OBSS. This may be achieved by analyzing the inter-BSS interference data embedded in the SIG (Signal) field of received frames. In some embodiments, the AP may periodically send commands to STAs to perform OBSS interference measurements. When the STAs receive commands, the STAs may conduct measurements by decoding the SIG field of received frames to identify inter-BSS and measure interference levels. The STAs may report back the collected measurement results to the AP. The AP may analyze the interference profile of the reported measurement results to determine optimal NPCA channel allocations. This procedure may be performed when the AP transmits beacon or probe response frames, or during the TWT setting negotiation phase between the AP and the STA.

For the low-latency traffic identification, APs may request STAs to report the presence of low-latency traffic such as latency-sensitive traffic, ultra-low latency (ULL) traffic requiring extremely minimal delay, or real-time traffic. Based on these reports, the AP may prioritize STAs with low-latency traffic and allocates NPCA channels to them. In some embodiments, the AP may broadcast a query to all associated STAs, requesting information on the presence of low-latency traffic. STAs with active low-latency traffic may respond with the required information. The AP may use this data to prioritize these STAs for NPCA channel access, ensuring minimal delays for critical applications. This procedure can also be performed during the TWT setting negotiation phase between the AP and the STA.

For peer-to-peer (P2P) communication, APs may inquire whether any STAs intend to engage in P2P communication. Priority is given to these STAs during NPCA channel allocation to facilitate efficient P2P interactions. In some embodiments, to facilitate P2P communication, the AP may periodically request STAs to indicate their intent for such interactions. STAs desiring P2P communication may respond to the AP's query. The AP may then schedule NPCA channel access for these STAs, ensuring efficient and interference-free P2P communication. This procedure can also be performed during the TWT setting negotiation phase between the AP and the STA.

By intelligently scheduling NPCA operations, the proposed method may alleviate and mitigate congestion on primary BSS channels and enhance overall network performance.

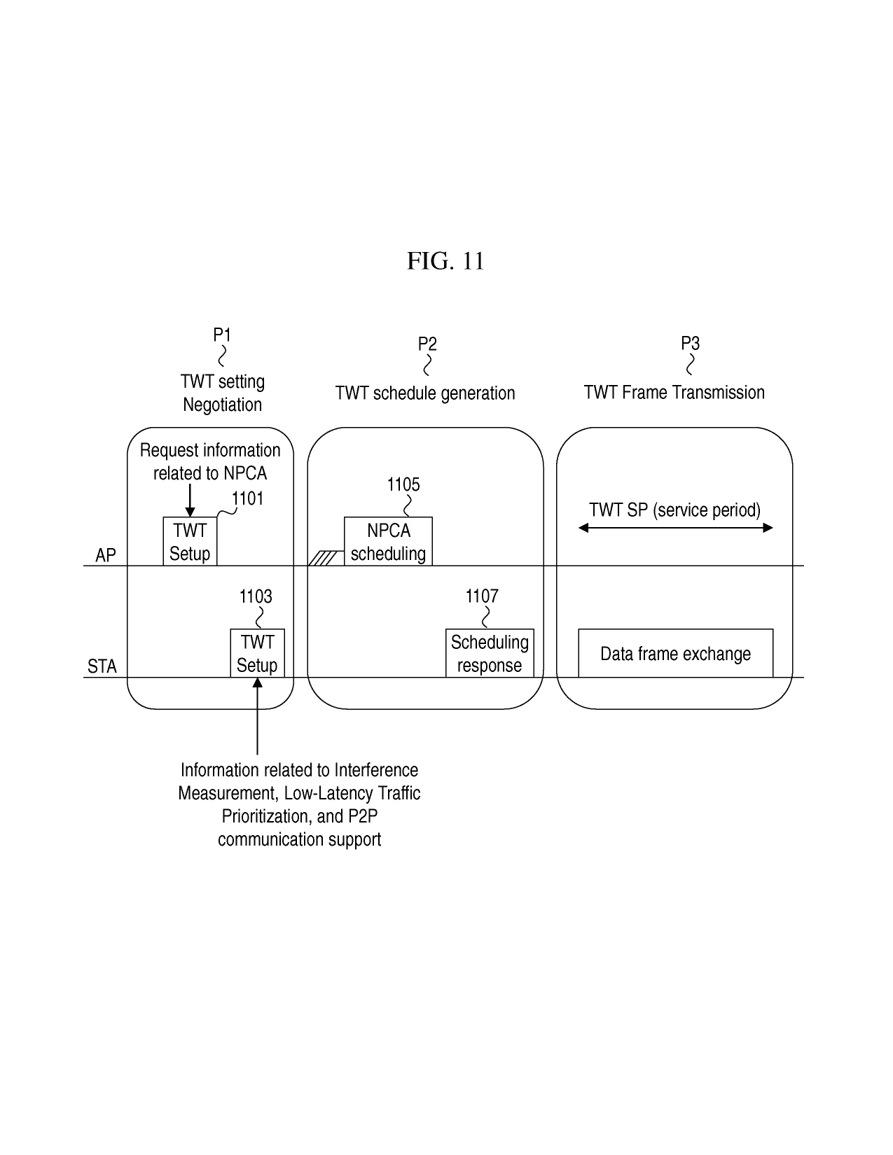

Hereinafter, the Scheduling Mechanism Using R-TWT will be described with reference to FIG. 11.

FIG. 11 illustrates a scheduling-based NPCA operation utilizing TWT in accordance with an embodiment.

The embodiment as shown in FIG. 11 can leverage the R-TWT mechanism to implement a structured scheduling framework. The following steps detail the R-TWT application in the NPCA context: a TWT setting negotiation phase P1, a TWT schedule generation phase P2, a STA sleep and wake management phase, and TWT frame transmission phase P3.

During the TWT setting negotiation phase P1, the AP and each STA may negotiate the parameters of the TWT session, including the TWT period (defining the data transmission cycle), active duration (the interval during which the STA remains awake), and reserved TWT intervals (specific time slots allocated for STA communication). This negotiation may also include information related to interference measurement, low-latency traffic prioritization, and P2P communication support, as described above.

During the TWT schedule generation phase P2, based on the negotiated parameters, the AP may create individual TWT schedules for each STA, ensuring efficient distribution of network resources. Using the information obtained from interference measurement, low-latency traffic prioritization, and P2P communication support, the AP may generate schedules tailored to the specific traffic requirements and interference profiles of the STAs.

In some embodiments, the NPCA scheduling may be activated when one or more of the following conditions are satisfied: - an OBSS interference level exceeds a predefined or dynamically determined threshold, - latency-sensitive traffic is detected, or - a P2P transmission intent is indicated by an STA.

In some embodiments, the NPCA primary channel may be selected based on at least one of a measured interference or historical channel quality metrics, or may be dynamically reselected for each R-TWT service period. These embodiments may provide flexibility in channel determination rather than impose a fixed selection rule.

During the STA sleep and wake management phase, STAs may operate in a low-power sleep mode outside their allocated TWT service periods. They may wake up only during their designated active periods to transmit or receive data, thereby reducing energy consumption.

During the active intervals of the TWT frame transmission phase P3, STAs and the AP may exchange data frames as per the TWT schedule. The structured timing reduces channel contention and improves transmission reliability. At the start of the active interval, STAs may switch to the NPCA channel scheduled during the TWT setting negotiation phase P1 to perform frame transmission.

Referring to FIG. 11, during the TWT setting negotiation Phase P1, the AP may transmit a TWT setup frame 1101 to the STA to request information required for NPCA operation. In some embodiments, the TWT request/response frame defined in the TWT operation of the Wi-Fi standard may be reused as the TWT setup frame. In some embodiments, information required for NPCA operation may include at least one of measurement information of interference caused by OBSS, information indicating whether the STA has traffic requiring low-latency, or information indicating that the STA intends to engage in the P2P communication.

The STA may respond by sending a TWT setup frame 1103 back to the AP. In some embodiments, the TWT setup frame 1103 may include the requested NPCA-related information. In some embodiments, the NPCA-related information may include at least one of measurement information of interference caused by OBSS, information indicating whether the STA has traffic requiring low-latency, or information indicating that the STA intends to engage in the P2P communication.

During the TWT schedule generation Phase P2, the AP may schedule the TWT Service Period (TWT SP) based on the NPCA-related information received from the STA. In some embodiments, the AP may schedule the TWT Service Period (TWT SP) based on at least one of measurement information of interference caused by OBSS, information indicating whether the STA has traffic requiring low-latency, or information indicating that the STA intends to engage in the P2P communication.

During the TWT schedule generation Phase P2, after the AP schedules one or more TWT service periods, the AP may send an NPCA scheduling frame 1105 including the scheduled TWT service periods to the STA. This frame may include NPCA scheduling information, specifying which channel the STA should switch to for exchanging data frames during the allocated time.

After reviewing the scheduling details, the STA may send back a scheduling response frame 1107, indicating its intention to participate.

In some embodiments, the STA may retain the decision-making authority to choose whether to perform NPCA operation during the TWT SP.

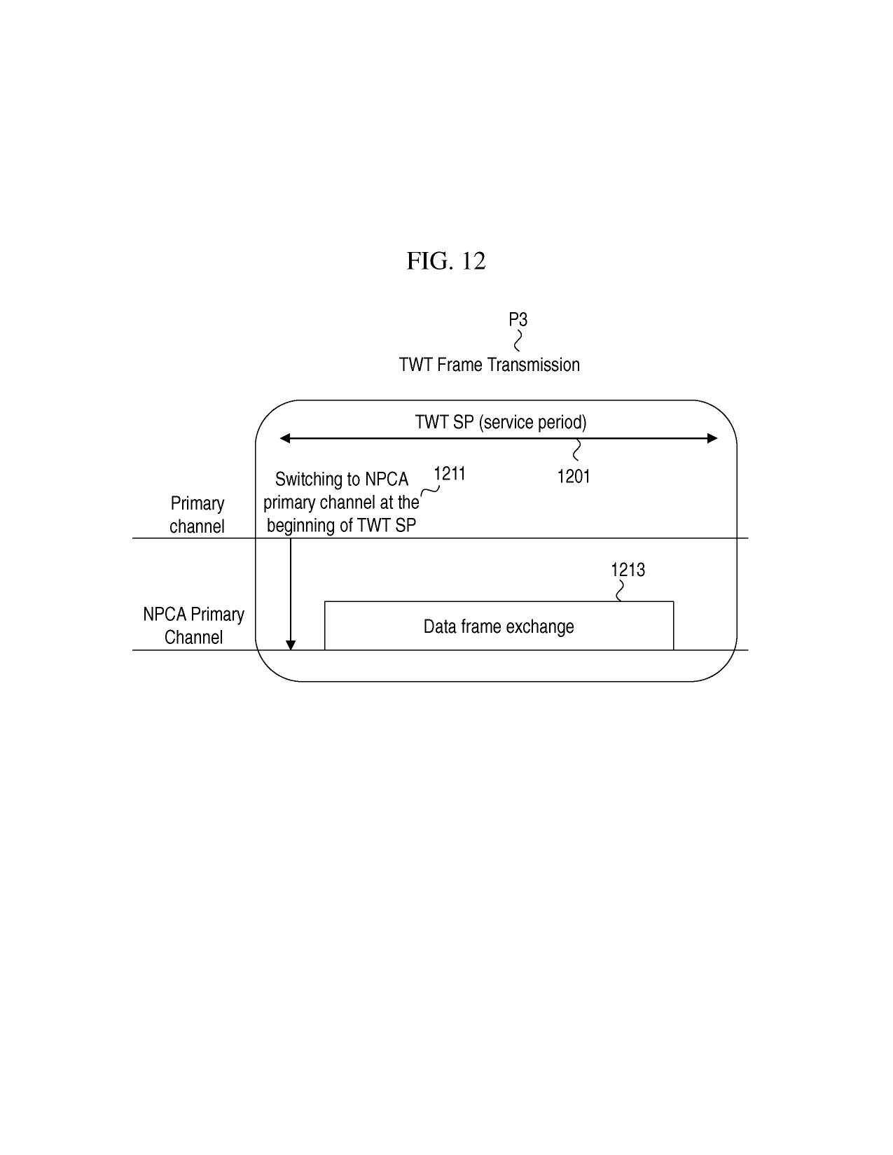

Hereinafter, the TWT frame transmission Phase will be described with reference to FIG. 12.

FIG. 12 shows a TWT frame transmission Phase in accordance with an embodiment.

During the TWT frame transmission phase P3, the STA may switch its operating channel from the BSS primary channel to the NPCA primary channel at the start of the TWT SP 1201 at 1211. During the TWT frame transmission phase P3, the STA may perform frame exchanges using the switched NPCA primary channel at 1213. In some embodiments, the STA may transmit data frames using the NPCA primary channel.

In some embodiments, the NPCA primary channel may be determined during the TWT setting negotiation phase P1 with the AP and communicated to the STA via the NPCA scheduling frame during the TWT schedule generation phase P2. The NPCA scheduling frame may inform the STA which TWT SPs among the allocated TWT SPs are designated for NPCA operation. In some embodiments, the NPCA scheduling frame may include one or more TWT parameters indicating one or more TWT service periods during which the NPCA operation is performed. For example, the one or more TWT parameters may include at least one of information indicating a start time of a TWT service period, information indicating a duration of a TWT service period, information indicating an interval between TWT service periods, and information indicating an NPCA primary channel.

By leveraging interference measurement, low-latency traffic prioritization, and P2P Communication Support, R-TWT may be selectively applied to certain STAs or applications, balancing flexibility with overall network efficiency. Utilizing the NPCA operation can further enhance channel utilization. This target approach may ensure optimal performance for time-sensitive traffic while maintaining resource availability for other users.

By offloading traffic to NPCA channels, the proposed method significantly reduces congestion on primary BSS channels. This improves overall network throughput and QoS, particularly for applications requiring low latency and high reliability.

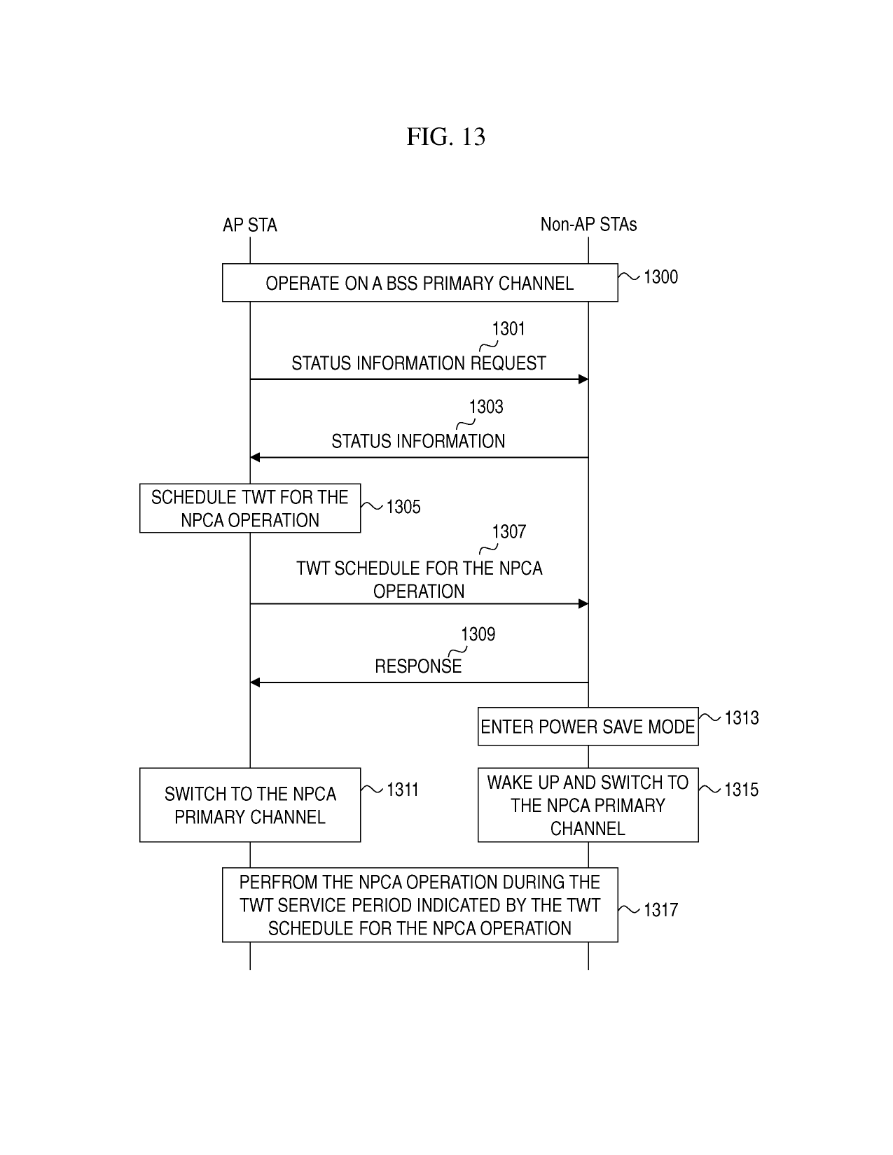

FIG. 13 shows a scheduling-based NPCA operation utilizing TWT in accordance with an embodiment.

Referring to FIG. 13, the AP station and one or more non-AP stations may operate on a BSS primary channel at 1300.

At 1301, the AP station may transmit a first frame including a status information request requesting one or more non-AP stations to send their status information to the AP station. In some embodiments, the AP station may transmit the status information request using the BSS primary channel. In some embodiments, the status information may include at least one of information on a level of interference caused by an overlapping basic service set (OBSS), information indicating whether the station has traffic requiring low-latency, or information indicating that the station intends to engage in a peer-to-peer (P2P) communication. In some embodiments, the AP station may transmit a TWT setup frame or other frame including the status information request to send the status information request.

At 1303, at least one of the one or more non-AP stations may transmit a second frame including the status information to the AP station in response to the status information request. In some embodiments, the non-AP stations may transmit the status information using the BSS primary channel. In some embodiments, the non-AP station may transmit a TWT setup frame or other frame including the status information to send the status information. In some embodiments, the status information may include at least one of information on a level of interference caused by an overlapping basic service set (OBSS), information indicating whether the station has traffic requiring low-latency, or information indicating that the station intends to engage in a peer-to-peer (P2P) communication.

At 1305, for one or more non-AP stations which responded to the status information request, the AP station may schedule target wake time (TWT) based on the status information to generate a TWT schedule for an NPCA operation. In some embodiments, the AP station may determine one or more non-AP stations selected for the TWT schedule for the NPCA operation based on the status information. In some embodiments, the AP station may determine one or more TWT parameters for the TWT schedule for the NPCA operation based on the status information. In some embodiments, the TWT parameters may indicate one or more TWT service periods during which the NPCA operation is performed. For example, the TWT parameters may include at least one of information indicating a start time of a TWT service period, information indicating a duration of a TWT service period, information indicating an interval between TWT service periods, and information indicating an NPCA primary channel. In some embodiments, the AP station may determine, based on the status information, the channel number of a channel to be used as the NPCA primary channel for the TWT schedule for the NPCA operation. For example, the AP station may determine the channel number of a channel to be used as the NPCA primary channel for the TWT schedule for the NPCA operation, based on at least one of information on a level of interference caused by an overlapping basic service set (OBSS), information indicating whether the station has traffic requiring low-latency, or information indicating that the station intends to engage in a peer-to-peer (P2P) communication.

In some embodiments, the AP station may schedule target wake time (TWT) for the NPCA operation if at least one of the following conditions is satisfied: i) the level of interference caused by an overlapping basic service set (OBSS) exceeds a predefined or dynamically determined threshold, ii) the station has traffic requiring low-latency, or iii) the station intends to engage in a P2P communication.

At 1307, the AP station may transmit a third frame including the TWT schedule for the NPCA operation to one or more non-AP stations which responded to the status information request or to one or more non-AP stations selected for the TWT schedule for the NPCA operation. In some embodiments, the AP station may transmit the third frame including the TWT schedule for the NPCA operation using the BSS primary channel. In some embodiments, the AP station may transmit an NPCA scheduling frame including the TWT schedule for the NPCA operation to send the TWT schedule for the NPCA operation. In some embodiments, the TWT schedule or the third frame may include identifiers of one or more non-AP stations selected for the TWT schedule, the TWT parameters, and an NPCA Primary Channel field indicating the channel number of a channel within a BSS bandwidth that corresponds to the channel that the AP and its associated non-AP STAs switch to in order to perform the NPCA operation.

At 1309, in response to the third frame, the one or more non-AP stations may transmit, to the AP station, a fourth frame including a response indicating intention to participate in the TWT schedule for the NPCA operation. In some embodiments, the non-AP stations may transmit the fourth frame including the response using the BSS primary channel.

At 1311, one or more non-AP stations which transmitted the response indicating intention to participate in the TWT schedule for the NPCA operation may enter a power save mode outside TWT service periods indicated by the TWT schedule for the NPCA operation.

At 1313, the AP station may switch its operating channel from a BSS primary channel to a NPCA primary channel at the beginning of a TWT service period indicated by the TWT schedule for the NPCA operation. In some embodiments, when the TWT schedule for the NPCA operation is for the P2P communication, the AP station may not switch its operating channel.

At 1315, one or more non-AP stations which transmitted the response indicating intention to participate in the TWT schedule for the NPCA operation may wake up and switch its operating channel from a BSS primary channel to a NPCA primary channel at the beginning of a TWT service period indicated by the TWT schedule for the NPCA operation.

At 1317, the AP station and one or more non-AP stations which transmitted the response indicating intention to participate in the TWT schedule for the NPCA operation may perform the NPCA operation using the NPCA primary channel during the TWT service period indicated by the TWT schedule for the NPCA operation. In some embodiments, the AP station and the non-AP stations may exchange data frames by using the NPCA primary channel during the TWT service period indicated by the TWT schedule for the NPCA operation. In some embodiments, when the TWT schedule for the NPCA operation is for the P2P communication, the non-AP station may perform P2P communication by using the NPCA primary channel during the TWT service period indicated by the TWT schedule for the NPCA operation.

The various illustrative blocks, units, modules, components, methods, operations, instructions, items, and algorithms may be implemented or performed with a processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A wireless communication device for facilitating wireless communication, comprising processing circuitry configured to cause:
transmitting, using a basic service set (BSS) primary channel, a target wake time (TWT) schedule for a non-primary channel access (NPCA) operation to a non-access point (non-AP) station (STA);
switching an operating channel from the BSS primary channel to a NPCA primary channel at the beginning of a TWT service period indicated by the TWT schedule for the NPCA operation; and
performing the NPCA operation using the NPCA primary channel during the TWT service period indicated by the TWT schedule for the NPCA operation.

2. The wireless communication device of claim 1, wherein the TWT schedule for the NPCA operation includes information indicating a channel number of a channel used for the NPCA primary channel.

3. The wireless communication device of claim 1, wherein the TWT schedule for the NPCA operation includes one or more TWT parameters indicating one or more TWT service periods during which the NPCA operation is performed.

4. The wireless communication device of claim 1, wherein the TWT schedule for the NPCA operation further includes information about one or more non-AP stations selected for the TWT schedule for the NPCA operation.

5. The wireless communication device of claim 1, wherein the processing circuitry is further configured to cause:
receiving status information from the non-AP STA; and
scheduling TWT based on the status information to generate the TWT schedule for the NPCA operation.

6. The wireless communication device of claim 5, wherein the status information includes at least one of information about a level of interference caused by an overlapping basic service set (OBSS), information indicating whether the non-AP STA has traffic requiring low-latency, or information indicating that the non-AP STA intends to engage in a peer-to-peer (P2P) communication.

7. The wireless communication device of claim 5, wherein the processing circuitry is further configured to cause:
transmitting a status information request requesting the non-AP STA to send status information of the non-AP STA.

8. The wireless communication device of claim 1, wherein the processing circuitry is further configured to cause:
receiving, from the non-AP STA, a response indicating the non-AP STA’s intention to participate in the TWT schedule for the NPCA operation.

9. A wireless communication device for facilitating wireless communication, comprising processing circuitry configured to cause:
receiving, using a basic service set (BSS) primary channel, a target wake time (TWT) schedule for a non-primary channel access (NPCA) operation from an access point (AP) station (STA);
entering a power save mode outside one or more TWT service periods indicated by the TWT schedule for the NPCA operation;
waking up and switching an operating channel from the BSS primary channel to a NPCA primary channel at the beginning of a TWT service period indicated by the TWT schedule for the NPCA operation; and
performing the NPCA operation using the NPCA primary channel during the TWT service period indicated by the TWT schedule for the NPCA operation.

10. The wireless communication device of claim 9, wherein the TWT schedule for the NPCA operation includes information about which channel is used for the NPCA primary channel.

11. The wireless communication device of claim 9, wherein the TWT schedule for the NPCA operation includes one or more TWT parameters indicating one or more TWT service periods during which the NPCA operation is performed.

12. The wireless communication device of claim 9 wherein the TWT schedule for the NPCA operation includes information about one or more non-AP stations selected for the TWT schedule for the NPCA operation.

13. The wireless communication device of claim 9, wherein the processing circuitry is further configured to cause:
transmitting status information to the AP STA.

14. The wireless communication device of claim 13, wherein the status information includes at least one of information about a level of interference caused by an overlapping basic service set (OBSS), information indicating whether the non-AP STA has traffic requiring low-latency, or information indicating that the non-AP STA intends to engage in a peer-to-peer (P2P) communication.

15. The wireless communication device of claim 12, wherein the processing circuitry is further configured to cause:
receiving a status information request requesting a station to send status information of the station.

16. The wireless communication device of claim 9, wherein the processing circuitry is further configured to cause:
transmitting, to the AP STA, a response indicating the station’s intention to participate in the TWT schedule for the NPCA operation.

17. The wireless communication device of claim 9, wherein performing the NPCA operation comprises:
performing wireless communication with the AP STA using the NPCA primary channel during the TWT service period indicated by the TWT schedule for the NPCA operation.

18. The wireless communication device of claim 9, wherein performing the NPCA operation comprises:
performing peer-to-peer communication with another non-AP STA using the NPCA primary channel during the TWT service period indicated by the TWT schedule for the NPCA operation.

19. A method performed by a wireless communication device for facilitating wireless communication, comprising:
receiving, using a basic service set (BSS) primary channel, a target wake time (TWT) schedule for a non-primary channel access (NPCA) operation from an access point (AP) station (STA);
entering a power save mode outside one or more TWT service periods indicated by the TWT schedule for the NPCA operation;
waking up and switching an operating channel from the BSS primary channel to a NPCA primary channel at the beginning of a TWT service period indicated by the TWT schedule for the NPCA operation; and
performing the NPCA operation using the NPCA primary channel during the TWT service period indicated by the TWT schedule for the NPCA operation.

20. The method of claim 19, further comprising:
transmitting status information to the AP STA.
